(19) United States
(12) Patent Application Publication
(10) Pub. No.: US 2009/0208403 A1
(43) Pub. Date: Aug. 20, 2009

(54) Novel catalyst to manufacture carbon nanotubes and hydrogen gas

(75) Inventors: Syed Tajammul Hussain, Islamabad (PK); Mohammed Mazhar, Islamabad (PK); Sheraz Gul, Islamabad (PK); M. Abdullah Khan, Islamabad (PK)

Correspondence Address: SARFARAZ K. NIAZI, 20 RIVERSIDE DRIVE, DEERFIELD, IL, 60015, US

(73) Assignee: Quaid-e-Azam University, Islamabad (PK)

(21) Appl. No.: 12/032,680

(22) Filed: Feb. 17, 2008

(51) Int. Cl. C01B 3/26; B01J 21/06; B01J 21/04; B01J 23/02; B01J 23/28; B01J 23/42; B01J 23/44; B01J 23/46; B01J 23/652; B01J 23/745; B01J 23/755; B01J 23/75; B01J 27/053; B01J 27/10; B01J 27/18; B01J 27/128; B01J 27/232; B01J 29/064; D01F 9/12

(52) U.S. Cl. 423/447.1; 502/337; 502/338; 502/339; 502/321; 502/325; 502/229; 502/230; 502/217; 502/174; 502/170; 502/213; 502/222; 502/223; 502/332; 502/333; 502/334; 502/335; 502/336; 502/328; 502/74; 423/651

(57) ABSTRACT

This invention relates primarily to a novel method to manufacture single/multi/fibers carbon filaments (nano tubes) in pure form optionally with antiferromagnetic and electrical property wherein the byproduct is hydrogen gas resulting in reduction of environmental carbon emissions by at least 20%; both carbon filaments and resultant exhaust are useful products.

### FILED OF INVENTION

This invention relates primarily to a composition of heavy metal catalyst novel method to manufacture single/multi/fibers carbon filaments (nanotubes) in pure form optionally with antiferromagnetic or electrical and magnetic properties wherein the byproduct is hydrogen gas resulting in reduction of environmental carbon emissions by at least 20%; both carbon filaments and resultant exhaust are useful products.

### BACKGROUND

Carbon nanotubes (CNTs) are allotropes of carbon. A single-walled carbon nanotube (SWNT) is a one-atom thick sheet of graphite (called graphene) rolled up into a seamless cylinder with diameter on the order of a nanometer. This results in a nanostructure where the length-to-diameter ratio exceeds 1,000,000. Such cylindrical carbon molecules have novel properties that make them potentially useful in many applications in nanotechnology, electronics, optics and other fields of materials science. They exhibit extraordinary strength and unique electrical properties, and are efficient conductors of heat. Inorganic nanotubes have also been synthesized.

Nanotubes are members of the fullerene structural family, which also includes buckyballs. Whereas buckyballs are spherical in shape, a nanotube is cylindrical, with at least one end typically capped with a hemisphere of the buckyball structure. Their name is derived from their size, since the diameter of a nanotube is in the order of a few nanometers (approximately 1/50,000th of the width of a human hair), while they can be up to several millimeters in length. Nanotubes are categorized as single-walled nanotubes (SWNTS) and multi-walled nanotubes (MWNTs).

The nature of the bonding of a nanotube is described by applied quantum chemistry, specifically, orbital hybridization. The chemical bonding of nanotubes are composed entirely of sp2 bonds, similar to those of graphite. This bonding structure, which is stronger than the sp3 bonds found in diamond, provides the molecules with their unique strength. Nanotubes naturally align themselves into “ropes” held together by Van der Waals forces. Under high pressure, nanotubes can merge together, trading some sp² bonds for sp³ bonds, giving great possibility for producing strong, unlimited-length wires through high-pressure nanotube linking

Most single-walled nanotubes (SWNT) have a diameter of close to 1 nanometer, with a tube length that can be many thousands of times longer. The structure of a SWNT can be conceptualized by wrapping a one-atom-thick layer of graphite called graphene into a seamless cylinder. The way the graphene sheet is wrapped is represented by a pair of indices (n,m) called the chiral vector. The integer n and m denote the number of unit vectors along two directions in the honeycomb crystal lattice of graphene. If m=0, the nanotubes are called “zigzag.” If n=m, the nanotubes are called “armchair.” Otherwise, they are called “chiral.”

Single-walled nanotubes are especially important because they exhibit important electric properties that are not shared by the multi-walled carbon nanotube (MWNT) variants. Single-walled nanotubes are the most likely candidate for miniaturizing electronics beyond the micro electromechanical scale that is currently the basis of modern electronics. The most basic building block of these systems is the electric wire, and SWNTs can be excellent conductors. One useful application of SWNTs is in the development of the first intramolecular field effect transistors (FETs). The production of the first intramolecular logic gate using SWNT FETs has recently become possible as well. To create a logic gate it is required to have both a p-FET and an n-FET. Because SWNTs are p-FETs when exposed to oxygen and n-FETs when unexposed to oxygen, it is possible to protect half of a SWNT from oxygen exposure, while exposing the other half to oxygen resulting in a single SWNT that acts as a NOT logic gate with both p and n-type FETs within the same molecule.

Single-walled nanotubes are still very expensive to produce, around $40-300$ per gram; thus, the development of more affordable synthesis techniques is vital to the future of carbon nanotechnology. If cheaper means of synthesis cannot be discovered, it would make it financially impossible to apply this technology to commercial-scale applications.

Multi-walled nanotubes (MWNT) consist of multiple layers of graphite rolled in on them to form a tube shape. There are two models which can be used to describe the structures of multi-walled nanotubes. In the Russian Doll model, sheets of graphite are arranged in concentric cylinders, e.g., a (0.8) single-walled nanotube (SWNT) within a larger (0.10) single-walled nanotube. In the Parchment model, a single sheet of graphite is rolled in around itself, resembling a scroll of parchment or a rolled up newspaper. The interlayer distance in multi-walled nanotubes is close to the distance between graphene layers in graphite, approximately 3.3 Å (330 pm).

The special place of double-walled carbon nanotubes (DWNT) must be emphasized here because they combine very similar morphology and properties as compared to SWNT, while improving significantly their resistance to chemicals. This is especially important when functionalisation is required (this means grafting of chemical functions at the surface of the nanotubes) to add new properties to the CNT. In the case of SWNT, covalent functionalisation will break some C═C double bonds, leaving “holes” in the structure on the nanotube and thus modifying both its mechanical and electrical properties. In the case of DWNT, only the outer wall is modified. The DWNT synthesis on the gram-scale was first proposed in 2003 by the CCVD technique, from the selective reduction of oxides solid solutions in methane and hydrogen.

Fullerites are the solid-state manifestation of fullerenes and related compounds and materials. Being of highly incompressible nanotube forms, polymerized single-walled nanotubes (P-SWNT) are a class of fullerites and are comparable to diamond in terms of hardness. However, due to the way that nanotubes intertwine, P-SWNTs do not have the corresponding crystal lattice that makes it possible to cut diamonds neatly. This structure results in a less brittle material, as any impact that the structure sustains is spread out throughout the material.

A nanotorus is a theoretically described carbon nanotube bent into a torus (doughnut shape). Nanotori have many unique properties, such as magnetic moments 1000 times larger than previously expected for certain specific radii. Properties such as magnetic moment, thermal stability, etc. vary widely depending on radius of the torus and radius of the tube.

Carbon nanobuds are a newly discovered material combining two previously discovered allotropes of carbon: carbon nanotubes and fullerenes. In this new material fullerene-like “buds” are covalently bonded to the outer sidewalls of the underlying carbon nanotube. This hybrid material has useful properties of both fullerenes and carbon nanotubes. In particular, they have been found to be exceptionally good field emitters.

Carbon nanotubes are the strongest and stiffest materials on earth, in terms of tensile strength and elastic modulus respectively. This strength results from the covalent sp² bonds formed between the individual carbon atoms. In 2000, a multi-walled carbon nanotube was tested to have a tensile strength of 63 GPa. Since carbon nanotubes have a low density for a solid of 1.3-1.4 g/cm³, its specific strength of up to 48,000 kN·m/kg is the best of known materials, compared to high-carbon steel's 154 kN·m/kg.

Under excessive tensile strain, the tubes will undergo plastic deformation, which means the deformation is permanent. This deformation begins at strains of approximately 5% and can increase the maximum strain the tube undergoes before fracture by releasing strain energy.

CNTs are not nearly as strong under compression. Because of their hollow structure and high aspect ratio, they tend to undergo buckling when placed under compressive, torsional or bending stress.

Carbon nanotubes/fibers are known for their conductive or semi-conductive properties due to the elongated tublous structure. These materials are considered commercially important for a number of new technologies and as replacement material for current technologies.

The production of single-wall carbon nanotubes (SWCNT), multi walled carbon nanotubes (MWCNT), carbon fibers (CF) were reported by lijima and co-workers at NEC and by Bethune and co-workers at IBM as early as 1993.

A number of synthesis method vertically aligned CNTs are known from the prior art. The majority of methods of synthesis comprise formation of catalyst layer on which CNTs are developed followed by their purification. It is a two step process, first the production of CNTs and then their purification, which is not economical for industrial applications. Popular methods for obtaining such a catalyst layer are sputtering, deposition processes, such as electron beam deposition, thermal deposition and the like. Preferred process for growing CNTs thereon include arc discharge, laser vaporization, gas phase synthesis, CVD (Chemical Vapor Deposition) method, Plasma enhanced chemical vapor deposition vapor-phase method, Alcohol catalytic chemical vapor deposition, High Pressure CO-disproportionation process, Flame synthesis (E T. Thostenson, Z. Ren, and T. W Chou, Composites Science and Technology, Vol. 61, 2001, p. 1899-1912).

The structure of a SWNT has been described as a single graphene sheet rolled into a seamless cylinder (Science of Fullerenes and Carbon Nanotubes, M. S Dresselhaus et al Ed., Academic Press. 1996).

In the arc-method, current is passed between carbon anode and cathode in a suitable container filled with a gas. An arc is created between the electrodes, and carbon evaporates from anode and deposits on the cathode. The cathode product is typically a mixture of different carbon nano structures. Subsequent separation and purification of the different structures can be made by e.g., liquid-liquid extraction methods.

In the laser ablation methods, a laser is used to evaporate carbon from graphite target. The evaporated carbon is carried by a gas flow to a cold collector, typically copper, where carbon nano structures are deposited. Separation and purification are normally also carried out.

In CVD, a carbon containing gas is decomposed and carbon nano structure is deposited on a suitable substrate. This method allows for high yields of desired structure, purification may not be required. Continuous production is also possible.

The reference G Z, Chen and D J, Fray, J. Min. Met., Vol. 39(1-2)B, p. 309-342, 2003 gives an overview of electrolytic formation of carbon material in molten salts. Typically, a graphite of carbonaceous anode and cathode are immersed in a molten alkali chloride electrolyte, and a current is passed between the electrodes. The carbon nano material is formed at the cathode. It is believed that the alkali metal interaction into carbon cathode is required for formation of nano structured carbon.

The plasma enhanced chemical vapor deposition (PECVD) involves a glow discharge in a chamber or a reaction furnace through a high frequency voltage applied to both the electrodes. A carbon containing gas such as C₂H₂, CH₄, C₂H₆, or CO is supplied to the chamber during the discharge. The catalytic metals such as Fe, Ni and CO are used on Si, SiO₂ or glass substrate. The catalyst has a strong effect on the nanotubes diameter, growth rate, wall thickness, and morphology and nano structures. This process is followed by purification of the prepared carbon materials.

In the vapor phase growth, pyrolysis, or the floating catalyst method is a method where in the carbon vapor and the catalytic metal particles both get deposited in the reaction chamber without a substrate. The diameter of the CNTs by vapor phase growth is in the range of 2-4 nm for SWNTs and between 70-100 nm for MWNTs. The pyrolysis set up consists of stainless steel gas flow lines and a two stage furnace system fitted with quartz tub. The ferrocene vapors carried by a 75% argon and 25% hydrogen mixture and passed over the metallocene catalyst at a flow rate of 900 SCCM into the furnace yields large quantity of carbon deposits mainly containing CNTs. The process required purification and followed by separation.

In the optical control plasma method the anode to cathode distance is adjusted in order to obtain strong visible vortices around the cathode. This enhances anode vaporization and improves nanotubes formation. Combined with argon/helium mixture over nickel and yttrium catalyst, the CNTs are produced in the ratio C/Ni/Y: 94.8:4.2:1. This then require purification to separate CNTs from Ni and Y particles.

In the method of laser vaporization the synthesis of CNTs is carried out when a pulsed laser is used to vaporize a graphite target in an oven at 1200° C. The oven is filled with helium or argon in order to keep the pressure at 500 torr. A hot vapor plume forms, then expands and cooled rapidly. As the vaporized species cool, small carbon molecules and atoms quickly condense to form large clusters, possibly including fullerence. The catalysts also begin to condense, but more slowly at first, and attach to carbon clusters and prevent the closing into cage structure. This is followed by purification of the formed carbon structures.

Pyrolysis or vapor phase deposition is carried out under controlled conditions of pyrolyis; dilute hydrocarbon-organometallic mixtures yield SWNTs. Pyrolyis of a mettallocene-acetylene mixtures at 1,100° C. yield SWNTs. The prepared carbon tubes were subjected to the purification process.

The CVD (Chemical Vapor Deposition) method is the straight-forward way to scale-up production at industrial level in comparison with other methods described above. The process is performed using Fe—Mo/Al₂O₃) catalyst. The product is contaminated with catalyst particles and needs extensive purification.

The alcohol-assisted catalytic chemical vapor deposition is a technique that has been developed for large scale production of high quality SWCTs at low cost. In this process evaporated alcohol (methanol and ethanol) are passed over the iron and cobalt catalyst particles supported on zeolites at 550° C. The product obtained is 85% pure and needs further purification. Also CO/CO₂ is produced with the production of hydrogen which cannot be used directly in the fuel cell system.

In the laser-assisted thermal-chemical vapor deposition, continuous wave of CO₂ laser which is perpendicularly directed on to the substrate pyrolyses sensitized mixtures of Fe(CO)₅ vapor and acetylene in a flow reactor. CNTs are formed by the catalyzing action of iron particles. By using the mixture of iron pentacarbonyl vapor, ethylene and acetylene, both SWNTs and MWNT's are formed; silica is used as the substrate. The contaminated CNT's are subjected to purification.

In the high pressure CO disproportionation process SWNTs are obtained using a gas-phase catalytic method involving the pyrolyis of Fe(CO)₅ and CO. This is performed at 1100° C. and at 2000 psig pressure and required purification of the end product.

The flame synthesis method is based on the use of controlled flame environment, where carbon atoms are formed from hydrocarbon fuels along with aerosols of metal catalyst The SWNTs grow on the metal islands. A sub monolayer film of metal (cobalt) catalyst was applied to the stainless steel by Physical Vapor Deposition (PVD). In this manner, metal islands resembling droplets were formed upon the mesh support to serve as catalyst particles. These small islands become the aerosol when exposed to flame. The reaction is carried out at 800° C. and requires purification. The hydrocarbon decomposition produces also CO/CO₂ contaminated hydrogen.

Smith et al (“Encapsulated C₆₀ in carbon nanotubes,” Nature, 1998, 396, 323-324) invented fullerence encased in a single walled carbon nanotubes (SWNTs) in acid purified nanotubes prepared by laser oven method. The produced material is called peapod. The prepared SWNTs required purification procedure to make it available for industries.

Many purification procedures have been developed to remove the inherent contaminants from carbonaceous sots produced to obtain the desired purified CNTs. These methods include hydrothermal treatment, gaseous or catalytic oxidation, nitric acid reflux, peroxide reflux, cross flow filtration, and chromatography. These treatments, chemically destroy the significant portion of the desired carbon nanotubes, require excessive production time and, in the case of arc-produced carbon fibers, have a marginal effect in purifying the desired carbon products from its impurities. It is also worth mentioning that many of the purification processes have not been quantitatively assessed with respect to the purity of the final product. Thus, they are of little aid to the skilled artisan in advancing the understanding of the purification procedures, additionally, reducing the predictably of successfully achieving a process of purifying carbon products.

Many processes which utilize hydrocarbon decomposition produce hydrogen which is enriched with CO/CO₂ contamination, thus increasing the overall economics of the product and consequently cannot be used directly in the fuel cell systems apart from increasing the concentration of green house gasses in the environment.

Furthermore, all the processes used to date for the production of CNTs either require high temperature or high pressure processes and need an extra purification step, which is a major obstacle in the economic manufacture and use of the CNTs. Apart from this, the hydrogen produced is contaminated with CO/CO₂ and consequently it cannot be used for fuel cell applications.

Therefore, it is an object of the present invention to provide an improved, simple and economical method of synthesizing carbon nanotubes which limits or avoids the above mentioned problems and simplifies the entire process. Yet another object of the present invention is to control the purity of CNTs production and producing modified fuel enriched with hydrogen for direct use in fuel cells. Furthermore, it is yet another object of the present invention to obtain a method and material which provides the control and influence of CNT during and/or after synthesis without requiring additional equipment or expense. Still, yet another object of the present invention is the use of CNTs for producing anti-ferromagnetic material by depositing Cu and Mo on to CNTs which have several industrial applications.

### REFERENCES

Abrahamson, John; Wiles, Peter G. & Rhoades, Brian L. (1999), “Structure of Carbon Fibers Found on Carbon Arc Anodes”, Carbon 37 (11): 1873

Beckman, Wendy. “UC Researchers Shatter World Records with Length of Carbon Nanotube Arrays”, University of Cincinnati, Apr. 27, 2007.

Belluci, S. “Carbon nanotubes: physics and applications”. Phys. Stat. Sol. (c) 2(1):34-47.

Bethune, D. S.; et al. (17 Jun. 1993). “Cobalt-catalysed growth of carbon nanotubes with single-atomic-layer walls”. Nature 363: 605-607. doi: 10.1038/363605a0.

Boyd, Jade. “Rice chemists create, grow nanotube seeds”, Rice University, Nov. 17, 2006.

Chae, H. G.; Kumar, S., “Rigid Rod Polymeric Fibers”. Journal of Applied Polymer Science 100:791-802.

Charlier, J. C., Blasé, X and Roche, S. (2007) Electronic and transport properties of nanotubes. Review of Modern Physics 79, 677 (2007)

Collins, Philip G.; Arnold, Michael S.; Avouris, Phaedon (Apr. 27, 2001). “Engineering Carbon Nanotubes and Nanotube Circuits Using Electrical Breakdown”. Science 292 (5517): 706-709.

Collins, Philip G.; Phaedon Avouris (December 2000). “Nanotubes for Electronics”. Scientific American: 67, 68, and 69.

Dalton, Alan B. (2003). “Super-tough carbon-nanotube fibres”. Nature 423 (6941): 703.

Dekker, Cees (May 1999). “Carbon nanotubes as molecular quantum wires”. Physics Today 52 (5): 22-28.

Demczyk, B. G.; Wang Y. M., Cumings J., Hetman M., Han W., Zettl A., Ritchie R. O. “Direct mechanical measurement of the tensile strength and elastic modulus of multiwalled carbon nanotubes”. Materials Science and Engineering A 334:173-178.

Duan, H. M.; and J. T. McKinnon (1994). “Nanoclusters Produced in Flames”. Journal of Physical Chemistry 98 (49): 12815-12818.

Ebbesen, T. W.; Ajayan, P. M. (1992). “Large-scale synthesis of carbon nanotubes”. Nature 358: 220-222.

Edwards, Brad C. (November 2003). The Space Elevator. B C Edwards. ISBN 0974651710.

Eftekhari, A.; Jafarkhani, Parvaneh; Moztarzadeh, Fathollah (2006). “High-yield synthesis of carbon nanotubes using a water-soluble catalyst support in catalytic chemical vapor deposition”. Carbon 44: 1343.

Endo, Morinobu & Dresselhaus, M. S. (Oct. 26, 2002), Carbon Fibers and Carbon Nanotubes (Interview, Nagano, Japan), <http://web.mit.edu/tinytech/Nanostructures/Spring2003/MDresselhaus/i789.pdf>.

Flahaut, E.; Bacsa R, Peigney A, Laurent C. (2003). “Gram-Scale CCVD Synthesis of Double-Walled Carbon Nanotubes”. Chemical Communications 12: 1442-1443.

Gannon, Christopher J.; Cherukuri, Paul; Yakobson, Boris I.; Cognet, Laurent; Kanzius, John. S.; Kittrell, Carter; Weisman, R. Bruce; Pasquali, Matteo; Schmidt, Howard K.; Smalley, Richard E.; Curley, Steven A. (2007). “Carbon nanotube-enhanced thermal destruction of cancer cells in a noninvasive radiofrequency field”. Cancer. Volume 110, Issue 12, Pages 2654-2665.

Guo, Ting (1995). “Catalytic growth of single-walled nanotubes by laser vaporization”. Chem. Phys. Lett. 243: 49-54.

Guo, Ting (1995). “Self-Assembly of Tubular Fullerenes”. J. Phys. Chem. 99: 10694-10697.

Height, M. J.; Howard, J. B.; Tester, J. W.; Vander Sande, J. B. (2004). “Flame synthesis of single-walled carbon nanotubes”. Carbon 42: 2295-2307.

http://carbon.phys.msu.ru/publications/1952-radushkevich-lukyanovich.pdf Radushkevich-Lukyanovich (1952) in Russian

http://www.assda.asn.au/

http://www.berkeley.edu/news/media/releases/2003/07/23_motor.shtml

http://www.nano-lab.com/imagegallery.html

http://www.nanotthinx.com

http://www.weizmann.ac.il/wagner/COURSES/Reading%20material%20(papers)/Encycl opedy_of_polymer_science_{—}2003.pdf.

Huhtala, Maria; Kuronen, Antti; Kaski, Kimmo (2002). “Carbon nanotube structures: molecular dynamics simulation at realistic limit”. Computer Physics Communications 146.

Iijama, Sumio (1993). “Single-shell carbon nanotubes of 1-nm diameter”. Nature 363: 603-605.

Iijima, Sumio (1991). “Helical microtubules of graphitic carbon”. Nature 354: 56-58.

Iijima, Sumio (1991). “Helical microtubules of graphitic carbon”. Nature 354: 56-58.

Inman, Mason. “Legendary Swords' Sharpness, Strength From Nanotubes, Study Says”, National Geographic, Nov. 16, 2006.

Inman, Mason. “Legendary Swords' Sharpness, Strength From Nanotubes, Study Says”, National Geographic News, Nov. 16, 2006.

Izvestiya Akademii Nauk SSSR, Metals. 1982, #3, p. 12-17 [in Russian]

José-Yacamán, M. (1993). “Catalytic growth of carbon microtubules with fullerene structure”. Appl. Phys. Lett. 62: 657.

Krätschmer, W. (1990). “Solid C60: a new form of carbon”. Nature 347: 354-358.

Kroto, H. W. (1985). “C60: Buckminsterfullerene”. Nature 318: 162-163.

Liu, Lei; Guo, G. Y.; Jayanthi, C. S.; and Wudate, S. Y. (2002). “Colossal Paramagnetic Moments in Metallic Carbon Nanotori”. Physical Review Letters 88 (21).

Martel, R.; V. Derycke, C. Lavoie, J. Appenzeller, K. K. Chan, J. Tersoff, and Ph. Avouris (December 2001). “Ambipolar Electrical Transport in Semiconducting Single-Wall Carbon Nanotubes”. Physical Review Letters 87 (25).

Meo, M.; Rossi M. “Prediction of Young's modulus of single wall carbon nanotubes by molecular-mechanics based finite element modelling”. Composites Science and Technology 66:1597-1605.

Meo, S. B.; Andrews R. “Carbon Nanotubes: Synthesis, Properties, and Applications”. Crit. Rev. Solid State Mater. Sci. 26(3): 145-249.

Monthioux, Marc; Kuznetsov, Vladimir L. (2006). “Who should be given the credit for the discovery of carbon nanotubes?”. Carbon 44.

Mukul Kumar et al 2007 Nanotubes from Camphor: An Environment-Friendly Nanotechnology Carbon J. Phys.: Conf. Ser. 61 643-646

Murr, L. E.; J. J. Bang, E. V. Esquivel, P. A. Guerrero, and D. A. Lopez (2004). “Carbon nanotubes, nanocrystal forms, and complex nanoparticle aggregates in common fuel-gas combustion sources and the ambient air”. Journal of Nanoparticle Research 6: 241-251.

Nano World: Nanotube toxicity exams differ. IBM. [http://www.upi.com/NewsTrack/Science/2006/06/01/nano_world_nanotube_toxicity_ex ams_differ/7376/]

New Scientist Tech, Secret's out for Saracen sabres Nov. 15, 2006.

Oberlin, A.; M. Endo, and T. Koyama, J. Cryst. Growth (March 1976). “Filamentous growth of carbon through benzene decomposition” 32: 335-349.

Porter, Alexandra (November, 2007). “Direct imaging of single-walled carbon nanotubes in cells”. Nature Nanotechnology 2 (11): 713-717.

Postma, Henk W. Ch.; Teepen, Tijs; Yao, Zhen; Grifoni, Milena; Dekker, Cees (2001). “Carbon Nanotube Single-Electron Transistors at Room Temperature”. Science 293 (5527).

Ren, Z. F. (1998). “Synthesis of Large Arrays of Well-Aligned Carbon Nanotubes on Glass”. Science 282: 1105.

Saveliev, A. V.; Merchan-Merchan, W.; Kennedy, L. A. (2003). “Metal catalyzed synthesis of carbon nanostructures in an opposed flow methane oxygen flame”. Combust. Flame 135: 27-33.

Sen, S.; Puri, I. K. (2004). “Flame synthesis of carbon nanofibres and nanofibre composites containing encapsulated metal particles”. Nanotechnology 15: 264-268.

Simmons, Trevor (2007). “Large Area-Aligned Arrays from Direct Deposition of Single-Wall Carbon Nanotubes”. J. Am. Chem. Soc. 129 (33): 10088-10089.

Singh, Ravi (2005). “Binding and condensation of plasmid DNA onto functionalized carbon nanotubes : Toward the construction of nanotube-based gene delivery vectors”. J. Am. Chem. Soc. 127 (12): 4388-4396.

Song, Jin; Dongmok, Whang; McAlpine, Michael C.; Friedman, Robin S.; Yue, Wu; Lieber, Charles M. (2004). “Scalable Interconnection and Integration of Nanowire Devices Without Registration”. Nano Letters 4 (5): 915-919.

Tesng, Yu-Chih (2004). “Monolithic Integration of Carbon Nanotube Devices with Silicon MOS Technology”. Nano Letters 4 (1): 123-127.

The Discovery of Single-Wall Carbon Nanotubes at IBM. [http://www.almaden.ibm.com/st/past_projects/nanotubes/?page6]

U.S. Pat. No. 4,663,230, “Carbon fibrils, method for producing same and compositions containing same”, granted May 5, 1987

Vander Wal, R. L. (2002). “Fe-catalyzed single-walled carbon nanotube synthesis within a flame environment”. Combust. Flame 130: 37-47.

Walker Jr., P. L. (1959). “Carbon Formation from Carbon Monoxide-Hydrogen Mixtures over Iron Catalysts.l. Properties of Carbon Formed”. J. Phys. Chem. 63: 133.

Yildirim, T.; et al. (2000). “Pressure-induced interlinking of carbon nanotubes”. Physical Review B 62: 19.

Yu, Min-Feng (2000). “Strength and Breaking Mechanism of Multiwalled Carbon Nanotubes Under Tensile Load”. Science 287: 637-640.

Yuan, Liming; Kozo Saito, Chunxu Pan, F. A. Williams, and A. S. Gordon (2001). “Nanotubes from methane flames”. Chemical physics letters 340: 237-241.

Yuan, Liming; Kozo Saito, Wenchong Hu, and Zhi Chen (2001). “Ethylene flame synthesis of well-aligned multi-walled carbon nanotubes”. Chemical physics letters 346: 23-28.

Zhang, Mei (2005). “Strong, Transparent, Multifunctional, Carbon Nanotube Sheets”. Science 309(5738): 1215-1219.

### SUMMARY OF INVENTION

An advantage of the present invention is that it is a facile process of obtaining carbon structure form hydrocarbons in high yield.

Another advantage of the present invention is the synthesis of purified carbon structure, ready to use and without the need for additional purification step.

Additional advantage of the present invention is the production of hydrogen enriched fuel which reduces environmental carbon emissions by at least 20%.

Yet another advantage of the present invention is the production of antiferromagnetic material by adding Cu and Mo inside the pores of CNTs.

Yet another additional advantage of the present invention is the process which continuously produces carbon structure.

Still yet another additional advantage of the present invention is the material which can reused after regeneration.

Still another feature of the present invention is the catalyst production process which results in the production of very fine particles (2-10 nm) range.

Additional advantages and other features of the invention will be set forth in part in the description which follows and in part will become apparent to those having skills in the art.

### DESCRIPTION OF INVENTION

According to the present invention, the foregoing and other advantages are achieved in part by a process which produces pure form of graphitic carbon directly without requiring purification. The said process comprises of dispersion of catalyst particles inside the silica discs and calcination at 600° C. for 4-hours to produce Ni:Cu catalyst particles inside the silicon disc thereby eliminating the contamination of catalyst particles in the carbon structure. Advantageously, the present invention process permits the production of CNTs in the 97-98% pure form.

The embodiments of the present invention include heating the catalyst material to 400° C. and then passing the liquid petroleum gas (LPG) at a flow of 100-2000 mL/min over the catalyst bed. The carbon formed is collected from the reactor tube and pure hydrogen produced can be used as a source of alternate energy.

Another aspect of the present invention is the design of the material comprises nickel, copper which restricts the formation of CO/CO₂ during the catalytic reaction. This material ranges from 5-30% by wt, more preferably 10-25% w/w embodied inside the pores of the silicon discs.

Another preferred feature of the present invention provides additional example of a catalytic material which contains 5-15% (preferably 1-10%) potassium apart from nickel and copper. This catalytic material prevents the formation of carbon products and in-turn produces hydrogen enriched modified fuel and other hydrocarbons which can be used as an alternate fuel, thus minimizing carbon emissions. The results are quite significant and teach a new technology to those involved in this art.

Yet another preferred feature of the present invention is the deposition of copper and molybdenum in the ratio inside the pores of CNTs to produce antiferromagnetic material for industrial applications.

The process of the present invention is worked at low temperature and at atmospheric pressure and produces substantial amount of carbon structures, hydrogen enriched fuel and antiferromagnetic material.

Yet another preferred feature of the present invention provides a catalyst production process that results in the production nano supported catalyst particles.

### EXAMPLES

The following are examples of the catalyst production according to aspects of the present invention. These examples are provided for exemplary purposes only are not intended to limit the scope of the present invention.

### Example 1

In a typical preparation of the heavy metal catalyst, 15.2520 g Ni(NO₃)₂.6H₂O and 1.4044 g Cu(NO₃)₂.3H₂O (amounts corresponding to 25% w/w Ni and 3% w/w Cu in the final catalyst) were dissolved in 10 mL distilled water (concentration for Ni(NO₃)₂.6H₂O 5.24 M and for Cu(NO₃)₂.3H₂O 0.58 M). This was minimum appropriate volume to get the optimum viscosity of solution so that it could be easily absorbed by the support disc. The critical flow of the precipitating agent is in between 2-5 mL/min. The temperature of reaction is 70-80° C. The solution was poured drop wise on the SCHOTT-DURAN filter disc (pore size 40-100 μm, diameter 33 mm), previously dried at 120° C. for 4 hours, until it was saturated with the solution. The disc was then dried at 90° C. for 4 hours and impregnation process repeated until the entire solution was consumed. After drying the impregnated disc overnight at 110° C., it was calcined at 650° C. for 6 hours.

### Example 2

High surface area catalyst embedded in a dried powder form is obtained by first combining the ceramic material with the metal salt solution in a vessel which is stirred continuously at room temperature for 0.5 hours. In the second step, 28% ammonium hydroxide (or any other precipitating agent) is added slowly, drop by drop, using such delivery devices as a HPLC pump to the vessel till the pH of the slurry reaches 12-14 as measured by a pH meter installed inside the vessel. The third step comprises of heating the slurry to 80-90° C. and keeping it at that temperature for 5-6 hours and during this time the pH comes down to 6-7. It is necessary to add water to the slurry to keep the volume constant to allow for evaporation. When the pH reaches between 6 and 7, this indicates deposition of Ni:Cu:K salts or any other metal salts on to ceramic support. In the fourth step, the slurry is filtered and washed 4-5 times with deionized water to remove any unreacted alkali (precipitating agent) from the prepared catalyst. In the fifth step, it is dried at 110° C. overnight and in the sixth step, it is calcined at 600° C. for 4-5 hours (to convert metals salt to respective oxides). The catalyst is now loaded into catalytic reactor, reduced under hydrogen at 450° 0 C. for 10-12 hours, before starting LPG (the reaction) over the catalyst bed. Doping with K results in the production of hydrocarbons and hydrogen gas and not the carbon nano structures as recorded when there is no K present in the supported catalyst.

The details of the prepared catalyst are presented below:

| | | | | Surface area |
|---|---|---|---|---|
| Catalyst Designation | % Ni | % Cu | % K | m²g⁻¹ |
| 25% Ni:3% Cu/Al | 24.3 | 2.96 | 0 | 196 |
| 25% Ni:3% Cu:1.0% K/Al | 23.98 | 2.9 | 0.9 | 225 |

### Example 3

Cants supported material prepared by the co-impregnation method described in the prior art with addition of copper and molybdenum, followed by drying and calcination at 600° C. for 6-hours.

| Catalyst Designation | % Cu | % Mo | CNT | Surface area m²g⁻¹ |
|---|---|---|---|---|
| 5% Cu:10% Mn/CNTs | 5.43 | 11.73 | Balance | 176 |

The temperature for the production of carbon fibers is 450° C. and SWCNTs 550° C., multi walled CNTs (MWCNTs) is around 600° C. The critical flow rate is 25-30 mL/min

### DESCRIPTION OF THE SEVERAL VIEWS OF THE DRAWINGS

In the following the process according to the invention is described in more details in the enclosed drawings, whereby

FIG. 1 shows the process flow diagram for the production of carbon structures and hydrogen enriched fuel.

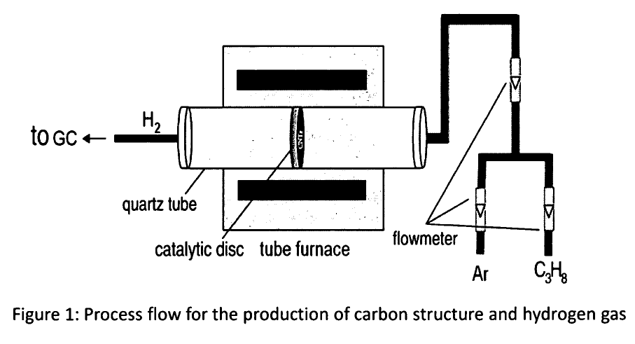

FIG. 2 shows the x-rays photo electron spectra of the prepared carbon structures, showing the purity achieved by the designed process.

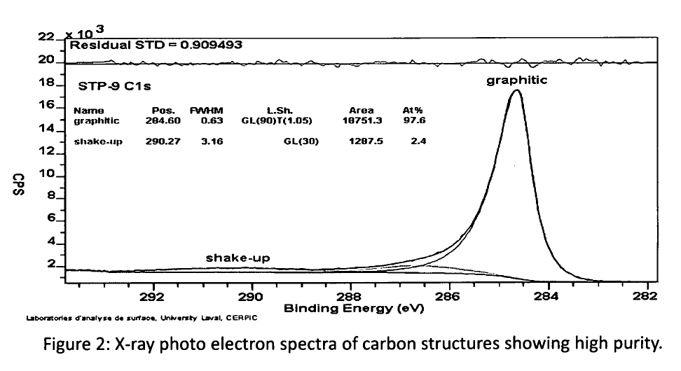

FIG. 3 shows the XRD spectrum of the prepared carbon structures showing the formation of pure graphitic carbon.

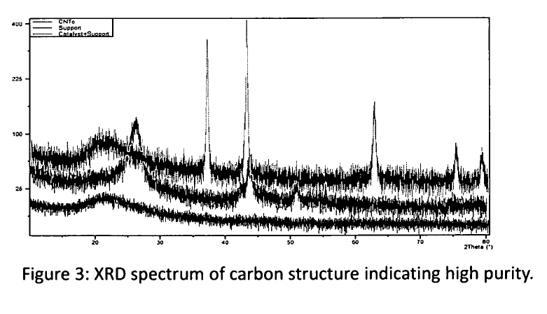

FIG. 4 shows the SEM micrographs of the SWCNTs, MWCNTs, carbon fibers.

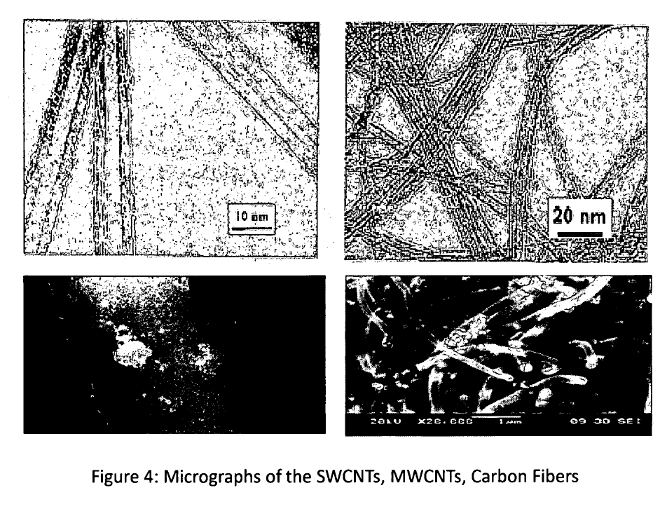

FIG. 5 shows the SEM micrographs of potassium doped material which only produces hydrogen and hydrocarbons.

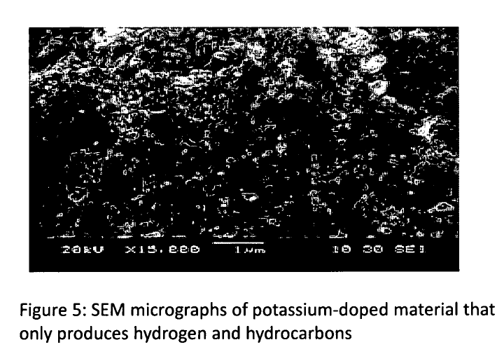

FIG. 6 shows the process for the production of supported catalysts.

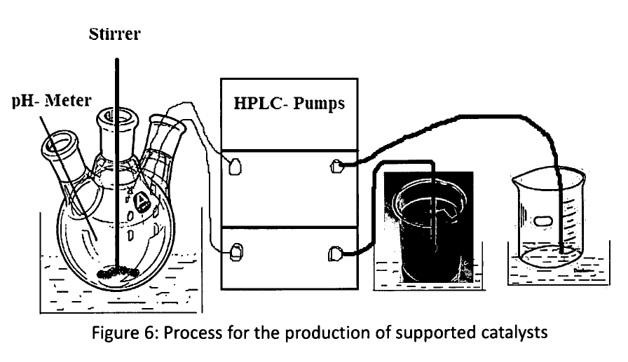

FIG. 7 depicts the particle size distribution of the prepared supported catalysts.

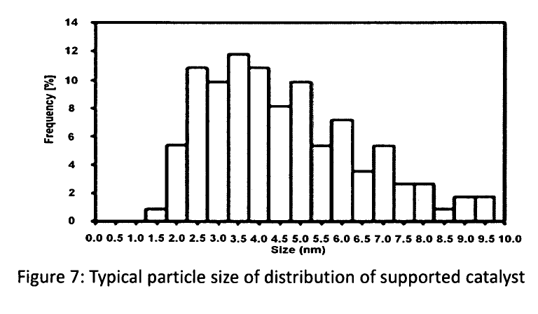

FIG. 8 shows a temperature vs. magnetic susceptibility plot demonstrating anti-ferromagnetic material property as a result of deposition of Cu and Mo inside the pores of produced carbon nanotubes.

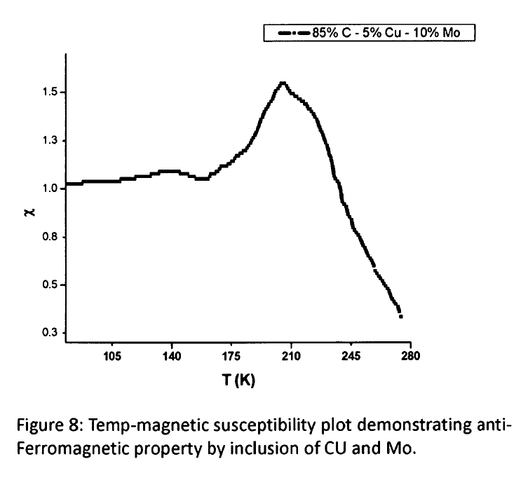

What is claimed is:

1. A catalyst composition comprising of nano crystals of heavy metals and optionally a doping agent embedded into a ceramic material support capable of converting liquid petroleum gas into carbon fibers and nano tubes and hydrogen gas.

2. The composition of claim 1 wherein said heavy metal catalyst is selected from the group consisting of Ni, Cu, Co, Ru, Fe, Pd, Pt, and Mo or a mixture thereof.

3. The composition of claim 1 wherein said heavy metal catalyst is in the form of oxides, chlorides, sulfates, carbonates, or acetates.

4. The composition of claim 1 wherein said doping agent is selected from the group consisting of K, Na, P, and S or a mixture thereof.

5. The composition of claim 1 wherein said doping agent is present in the concentration of 3-20%.

6. The composition of claim 1 wherein said ceramic material support is selected from the group consisting of alumina, titanium, magnesium, and zeolite or a combination thereof.

7. The composition of claim 1 wherein said ceramic material support is in the shape of a disc.

8. The composition of claim 1 wherein said heavy metal catalyst is embedded into ceramic material support system by controlled precipitation of heavy metal salt solution and drying the ceramic material support at 120° C. overnight and then calcinating the supported catalyst at 500-650° C. for 14 hours.

9. The composition of claim 1 wherein the heavy metal catalyst particle size is in the range of 2-15 nm.

10. The composition of claim 1 wherein said heavy metal catalyst concentration is 10-75% by weight after embedding into ceramic material support.

11. A method of manufacturing hydrogen gas comprising of the steps of (a) depositing said catalyst comprising of nickel, copper and potassium on said ceramic support by: (i) forming a slurry of said catalyst with ceramic support; (ii) adding to said slurry, ammonium hydroxide 28% gradually until the pH rises to 12-14; (iii) heating said slurry to 80-90° C. for 5-6 hours until the pH drops to 5-6; b) filtering said slurry and washing with deionized water; c) drying said supported catalyst particles at 110° C. overnight; d) calcining said supported catalyst particles at 600° C. for 4-5 hours; d) charging a catalysis reactor; (e) reducing said catalyst under hydrogen at 450° C. for 10-12 hours; (f) passing said liquid petroleum gas; (g) recover hydrogen gas as by product of reaction.

12. A method of manufacturing carbon fibers, single-walled and multi-walled carbon nano tubes comprising of the steps of activating said catalyst of claim 1 comprising of nickel and copper under hydrogen at 600° C. for 12 hours, cooling said catalyst to 400° C. prior to passing said liquid petroleum gas at flow rates of 100-2000 mL/min.

13. The method of claim 12 wherein said carbon nano tubes have purity in excess of 97%.

14. The method of claim 12 wherein said supported catalyst is maintained at a temperature of 600° C. in a catalytic reactor and the flow rate of said liquid petroleum gas is 25-30 mL/min to produce carbon nano tubes which are multi-walled.

15. The method of claim 12 wherein said supported catalyst is maintained at a temperature of 450° C. in a catalytic reactor and the flow rate of said liquid petroleum gas is 25-30 mL/min to produce carbon nano tubes which are straight carbon fibers.

16. The method of claim 12 wherein said supported catalyst is maintained at a temperature of 550° C. in a catalytic reactor and the flow rate of said liquid petroleum gas is 25-30 mL/min to produce carbon nano tubes which are single-walled.

17. The method of claim 12 wherein said carbon nano tubes and carbon fibers are additionally doped with Cu and Mo to impart said carbon nano tubes and carbon fibers an anti-ferromagnetic property.

18. The method of claim 17 wherein the concentration and doped Cu and Mo ranges from 5-20%.

19. The method of claim 12 wherein said carbon nano tubes and carbon fibers are additionally doped with a polymeric material to impart magnetic and electrical properties to said carbon nano tubes and carbon fibers.

20. The method of claim 19 wherein the concentration of said polymeric material ranges from 50-98%.
